(19) United States
(12) Patent Application Publication
(10) Pub. No.: US 2017/0297176 A1
(43) Pub. Date: Oct. 19, 2017

(54) TOOL AND METHOD FOR APPLYING TORQUE

(71) Applicant: Benyamin Grolman, Alno (SE)

(72) Inventor: Benyamin Grolman, Alno (SE)

(21) Appl. No.: 15/637,841

(22) Filed: Jun. 29, 2017

Related U.S. Application Data
(63) Continuation of application No. 14/792,741, filed on Jul. 7, 2015.
Application No. 14/792,741 is a continuation of application No. 13/101,687, filed on May 5, 2011, now abandoned.
Application No. 13/101,687 is a continuation-in-part of application No. PCT/SE2009/000485, filed on Nov. 3, 2009.

(30) Foreign Application Priority Data
Nov. 5, 2008 (SE) 0802350-9

(51) Int. Cl. B25B 13/32; B25B 13/16; B25B 13/14; B25B 7/10; B25B 7/04; B25B 13/58; B25B 7/02

(52) U.S. Cl. CPC B25B 13/32; B25B 13/58; B25B 13/16; B25B 7/02; B25B 7/10; B25B 7/04; B25B 13/14

(57) ABSTRACT

The invention regards a tool (1) for applying torque to an maneuvered object, such as for example a screw head or nut, including at least a first jaw (4), and at least a second jaw (5) where the first jaw (4) and the second jaw (5) are connected to at least one lever (arm) (2). What is unique with the tool is that at least one of the jaws (4, 5) includes at least one recess (7) with a first contact surface (8) and a second contact surface (9) of which at least one of the contact surfaces (8) and (9) is arch-shaped. A method of using the tool is also disclosed.

### CROSS REFERENCE TO RELATED APPLICATIONS

This application is a continuation-in-part application filed under 35 U.S.C. §111a of International Patent Application No. PCT/SE2009/000485, filed Nov. 3, 2009, of which International Patent Application No. PCT/SE2009/000485, filed Nov. 3, 2009, claims priority to Swedish Patent Application No. 0802350-9, filed Nov. 5, 2008. The disclosure of each of the above-identified related applications is hereby fully incorporated herein by reference.

### TECHNICAL FIELD

The present invention concerns a tool. More specifically the present invention regards a tool or an accessory to tools in accordance with the claims.

### BACKGROUND OF THE INVENTION

In a variety of contexts, there is a need to securely hold an object in order to allow for a detail or similar to be worked on. This usually presents a problem if the work to be done includes such a process as to transfer torque to the held object. A tool designed for the task of securely holding an object is often not suited for the transmission of torque. Tools that are good for applying torque such as crescent wrenches (adjustable spanners) or open-end or box-end wrenches have the disadvantage that they are usually designed to fit some predetermined shapes (square, hexagonal, etcetera) and dimensions. These can hardly be used for other shapes and dimensions than their predetermined ones.

A common need is to tighten or loosen a screw, bolt, nut or similar from each other and also to and from other objects. Sometimes a problem occurs with parts of the torque (tightening) surface being worn or damaged, for example, that one corner or several corners of a nut are worn (rounded), which makes tightening and/or loosening difficult. There is a need for an object that can assist existing tools to hold firmly, and also allow the required application of torque, such as tightening and loosening to the desired contact surface.

A further need exists to adjust a tool according to the dimensions to be handled. In connection with the tightening and loosening of screws, bolts, nuts and the like, there is a need to adjust which dimensions the tool is to be operated with. It is usually a significant problem to use a tool outside its intended area regarding shape and dimension. It can often be difficult to carry around all the different types of tools required to perform work outside of for example a shop where there are storage areas for these tools. It can also often be difficult to predict which tools will be needed to perform the job in question. There is a need for aids or accessories to existing tools that can remedy this and also the other problems mentioned above.

Furthermore, there are also needs in special cases, where great care must be taken to an object's appearance or accuracy so that the application of torque does not cause any negative damage (scratches, worn corners or edges, etcetera) to the objects. This may occur during installation and mounting of for example art objects, jewelry or other decoration or sophisticated scientific equipment specially designed for very specific purposes. Thus, there is a need for aids that can ensure that tools used for the application of torque do not slip or otherwise lose their grip in an unwanted manner.

A further problem with known types of crescent wrenches is that the object which the torque is to be applied to, can slide out of the tool in connection with the object being maneuvered with the crescent wrench. This may for example lead to the head of a screw, nut or the like being worn (rounded) that is to say damaged. Furthermore, the person performing the work with the crescent wrench may easily harm themselves, for example on the hand with which the crescent wrench is operated in conjunction with the crescent wrench involuntarily loosening from the maneuvered object.

Yet another problem with known crescent wrenches is that they have a certain amount of play in them which may easily cause wear and tear on screw heads and the like.

### PRIOR ART

Tools of the crescent wrench type, which were originally named screw wrenches by the inventor J. P. Johansson, are already known. For example the original crescent wrench is described in the Swedish patent SE4066. The crescent wrench has proved a great commercial success and has sold in huge numbers. Furthermore, tools such as open-end and block-end wrenches have long been known to exist. These are limited to a specific size. Further, so-called water-pump pliers have also been developed.

These previously known tools have a number of shortcomings which limit their utility. For example, it is not possible to operate all types of objects with these pliers. In the applicant's patent application SE0700664 is described an accessory to a tool which includes arch-shaped contact surfaces. The design in accordance with patent application SE0700664 differs greatly from the present invention. For example, the design of patent application SE0700664 is not intended to be used to apply torque to an object, but is designed to hold and temporarily fixate one or more objects.

Patent documents U.S. Pat. No. 5,239,899, U.S. Pat. No. 6,370,989, U.S.2004163504A1 and AU 672035B2 describe a tool intended to apply torque to a worked object such as a screw head or a nut. Theses designs have a similarity with the present invention in that they include at least one arch-shaped contact surface. In other respects, these designs differ greatly according to the design of the present invention. For example, the screw or nut maneuvered by the tools can easily slip out of the tools' grip, unlike the design described in patent application 0802350-9. The design according to the present invention allows for the complete balance between the vectors from the lower side and the upper side, gripping the object. This mechanical equilibrium of vectors contributes to prevent the tendency of objects to escape from the grip.

U.S.2004163504A1 and AU 672035B2 have unequal distance powers of torque between the different vectors active on the object and the center of the object (the center of mass facing external torque), causing extra strains increasing the object's tendency to escape from the grip. Furthermore U.S.2004163504A1 and AU 672035B2 do not include a design with adjustable jaws. Furthermore U.S.2004163504A1 and AU 672035B2 do not include designs with interchangeable jaws in accordance with an embodiment of the present invention.

Patent document U.S. Pat. No. 4,718,315 describes a variant of a tool design. The design has similarities to that of the present invention in a variant that includes removable jaws. The design is substantially different in other respects from the design of the present invention. For example, the tool according to patent document U.S. Pat. No. 4,718,315, unlike the present invention, may not be used with both the jaw accessory and without the jaw accessory. The design also has the problem that there is a risk that the object to be maneuvered (screw head or the like) may slip from the tool. Furthermore the design is not intended to hold objects of many different shapes. Unlike the design found in patent document U.S. Pat. No. 4,718,315, the present invention can hold, while a significant torque is being implemented by the tool, almost any symmetric object, for example hexagonal nuts, circular pipes, square profiles or even unsymmetrical shapes like triangles and so forth without damaging (wearing down the corners) the object.

Patent document U.S. Pat. No. 5,131,312 describes a variant of a tool which in one embodiment is made up of a crescent wrench. The crescent wrench embodiment includes adjustable jaws. In other respects, the design according to the patent differs in significant ways in accordance with the present invention. For example, the design does not include the arch-shaped contact surface.

Even if each of the above designs can by themselves meet their own objectives, none of these have a design in accordance with the present invention.

### BRIEF DESCRIPTION OF THE INVENTION

The main purpose of the present invention is to achieve a significantly improved tool for holding objects and for applying torque to a screw head, nut or the like, preventing the tendency of objects to escape from the grip. A further aim of the present invention is to provide a tool that allows for one and the same tool to be used for many more shapes and sizes than what it was designed for, i.e. almost any symmetric object, for example hexagonal nuts, circular pipes, square profiles or even unsymmetrical shapes like triangles and so forth. Yet a further objective is to create an aid (tool) that is capable of applying in a reliable and very gentle manner torque to and between objects which are very sensitive to negative damage; i.e., without damaging (wearing down the corners) the object.

Further aspect of the invention will become apparent by the following detailed description and also the appended claims.

### BRIEF DESCRIPTION OF THE FIGURES

The invention will be described in detail in the following text with reference to the enclosed schematic drawings that in an exemplifying purpose show preferred embodiments of the invention, wherein;

FIG. 1 shows schematically the present invention in perspective.

FIG. 2 shows an alternative embodiment of contact surfaces.

FIG. 3 shows a second alternative embodiment of the present invention.

FIG. 4 shows a third alternative embodiment of the present invention,

FIG. 5 shows a fourth alternative embodiment for the present invention,

FIG. 6 shows a fifth embodiment in accordance with the present invention,

FIG. 7 shows a sixth alternative embodiment in accordance with the invention,

FIGS. 8 and 9 show a seventh embodiment in accordance with the invention, and

FIGS. 10 and 11 show a modification of the embodiment shown in FIG. 7.

### DETAILED DESCRIPTION OF THE INVENTION

With reference to the figures a tool 1 in accordance with the present invention is shown. The design includes at least one lever (arm) 2 and at least one grip 3 whose grip includes at least a first jaw 4 and a second jaw 5. The lever 2 is preferably made up of a handle (shaft) or the like. The jaws' 4 and 5 design may vary greatly within the scope of the present invention.

Further the jaws' 4 and 5 relative positions (distance) to each other are preferably arranged to be adjustable with a maneuvering (adjustment) organ 6. This adjustment can be accomplished by one jaw being fixed and the other movably arranged such as is the case of a crescent wrench, water-pump pliers or similar.

Alternatively, the tool may be so designed that both jaws are movably arranged.

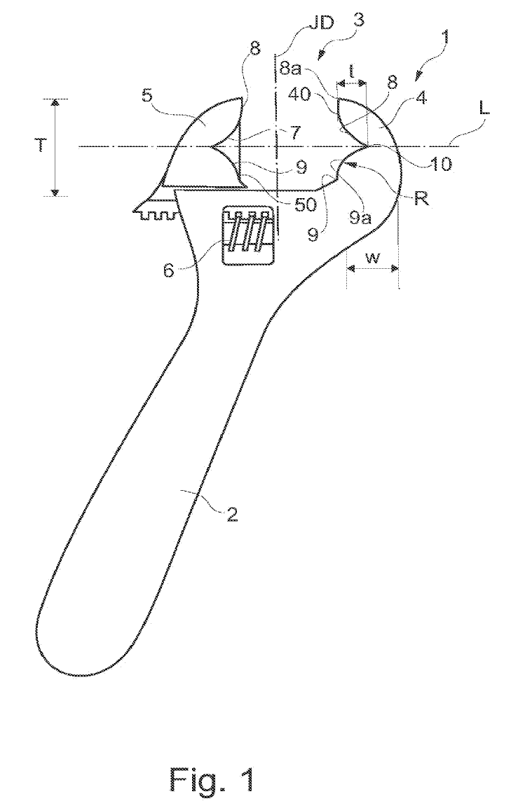

The handle's (lever's) design may vary greatly within the scope of the present invention. For example, the handle may have a similar design as known types of crescent wrenches or the like as for example shown in FIG. 1. Alternatively, the handle (lever) may consist of a first and a second maneuvering organ such as is the case of water-pump pliers shown in FIG. 3.

What is unique with the present invention is that each respective jaw includes at least one recess 7. The recess 7 includes a first contact surface 8 and a second contact surface 9 which connect to each other in a point 10. Contact surfaces 8 and 9 may be arch-shaped or straight.

In the first embodiment, shown in FIG. 1, the first contact surface 8 and the second contact surface 9 are arch-shaped. The arch-shape may be of an elliptical shape, radial shape or another for the purpose suitable shape. The first contact surface 8 and the second contact surface 9 converge into a point 10. The first arch-shaped contact surface (8) and the second arch-shaped contact surface (9) essentially converge at a point (10) or converge into a point (10) and the direction of the arch-shaped convergence is essentially in a latitudinal direction L in relation to the direction DJ of the jaws (4) and (5). Accordingly, as is apparent from FIG. 1 a latitudinal line L in relation to the direction of the jaws JD, will pass through both interconnecting points 10 of opposing, interacting recesses 7 of the jaws 4, 5. Further, FIG. 1 shows that the depth t of each recess 7 is relatively large, i.e. in the size of about a third of the longitudinal extension T of the grip 3, and/or alternatively expressed about 0.4 of the width W of the jaw 4, 5. In FIG. 1 there is shown an embodiment where T generally corresponds to the distance between the starting points 8a, 9a of each recess. However even if this in many is a preferred relationship, it is evident for the skilled person that sometimes the depth t may be much smaller than Tₜₒₜ in relation to the extension of the jaws. For the skilled person it is evident that also a smaller, or a larger, depth t may be desired depending on the use of the tool, but normally the depth t will be above 0.1 T and up to 0.6 T, (assuming a relatively equal size of longitudinal extension of the grip 3 as the extension between the starting points 8a, 9a of the recess 7), and/or 0.1-0.7 W. The radius R of the arch-shaped surfaces 8, 9 would normally be within the range 0.3-1.5 t, depending on specific design adaptations, whereby should be understood that the curvature along the arch-shaped surface 8, 9 may vary and indeed at least in the area near the intersection point 10 be infinit (i.e. transform into a straight line), possibly combined with an inverse curvature in the area of the intersection point 10. It is evident for the skilled person that therefore the radius R shown in FIG. 1 should be understood as a kind of mean radius R used for the main part of the arch-shaped surface 8, 9 forming the converging, curved main part of each surface 8, 9 having its starting point at an upper gripping surface level 40 and 50 respectively, of each jaw 4, 5. In some application it may be an advantage to use the following thumb rules regarding R;
If t<0.5 T then
Rmin=t (in the latitude direction of R)
Rmax=T/2 (in the longitude direction of R)
If t>0.5 T then
Rmax=t (in the latitude direction of R)
Rmin=T/2 (in the longitude direction of R)

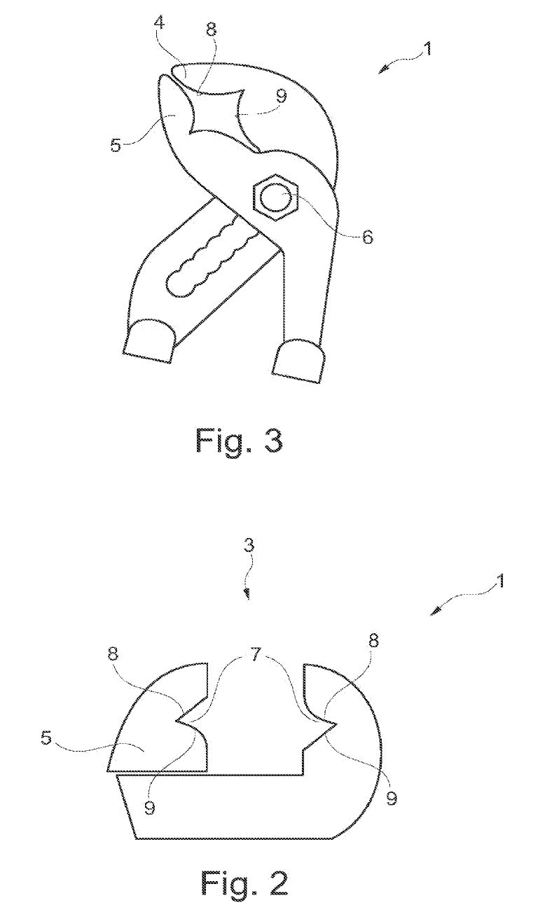

FIGS. 2 shows an alternative embodiment of the present invention; i.e., that the contact surfaces 8 or 9 may be arch-shaped and the other of the contact surfaces 8 or 9 may be straight.

FIG. 1 shows more specifically a tool of a crescent wrench type where the jaws 4 and 5 are fitted with arch-shaped contact surfaces 8 and 9. FIG. 3 shows a variant of the tool according to the present invention where it is essentially made up of tool of a water-pump pliers type. FIG. 3 does not show the parts of the handle, it is however formed in accordance with known techniques.

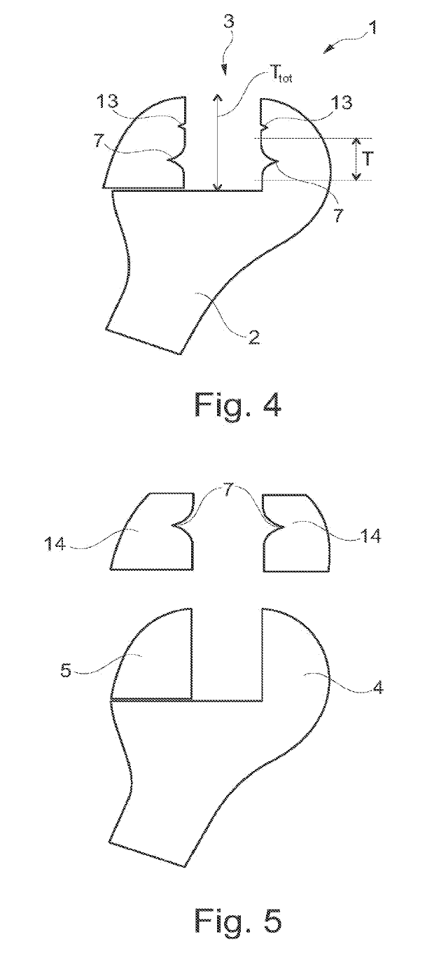

FIG. 4 shows a variant of the present invention where each respective jaw 4 and 5 is fitted with a first recess 7 and a second recess 13 with arch-shaped contact surfaces 8 and 9. The design may consist of a tool with a similar design such as a crescent wrench, water-pump pliers or other for the purpose suitable tool with recesses 7 with arch-shaped contact surfaces 8 and 9. FIG. 4 does not show the handle, it is however formed in accordance with known techniques. As is apparent from Fig. 4 there is no need to have a substantially correspondence regarding the distance T between starting points of recess 7 and the total longitudinal extension Tₜₒₜ, especially in a case like the one shown in FIG. 4 where the jaws 4, 5 are arranged to be functional for objects of substantially different size, by the use of a first pair of recesses 13 with a relatively small depth t₁₃and a second pair of recesses 7 having a depth t₇ that is at least about twice the size of the depth of the first pair 13. In such a case there will of course be a need of using a total longitudinal extension Tₜₒₜ that is substantially larger than the distance between the starting points of the recesses 7, 13. In general it may be preferred to have tin a preferred range of 0.2-0.5 T, wherein T refers to the distance between the starting points of a corresponding recess.

FIG. 5 shows more specifically a tool with removable jaws 14 and 15. The removable jaws 14 and 15 may be applied to existing jaws such as shown for example in FIG. 2. The removable jaws 14 and 15 each include at least one recess 7 with at least one arch-shaped contact surface 8 or 9. In the figure is shown a variant where both the contact surface 8 and the contact surface 9 arc arch-shaped. In other respects the jaws' 14 and 15 shape and size may vary greatly within the scope of the present invention. A tool in accordance with the present invention may thereby both be used such as a tool with the advantages in accordance with the present invention and even be used such as earlier known tools such as a crescent wrench, water-pump pliers or other corresponding tool.

In alternative embodiments the adjustment device (organ) on the tool may be of an automatic type such as one marketed by Black & Decker. Alternatively, the adjustment device may be made up of another previously known adjusting device or in the future developed adjustment device which is suitable for purpose. In alternative embodiments the contact surfaces may be fitted with transversal grooves (not shown in the figures) in one or more directions. It is conceivable for example that the contact surfaces are entirely or partly knurled.

It is conceivable that the present invention only be defined as an accessory to an existing tool. The invention is then only made up of a jaw as shown in designations 14 and 15, as shown in FIG. 5.

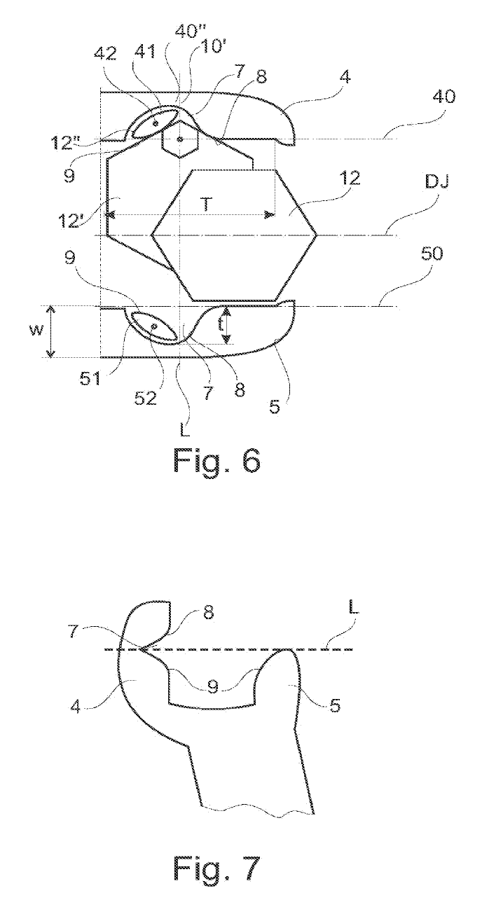

In FIG. 6 there is shown a further embodiment in accordance with the invention. There is shown that the first arch-shaped surface 8 of each recess 7 is made of a fixed surface integrated with the jaws 4, 5. Furthermore there is shown a pivotable member 41, 51 positioned within each recess 7, to provide the interacting arch-shaped other surface 9, within each recess 7. The pivoting elements 41, 51 are pivotally arranged around an axis 42, 52 that is fixed in relation to each one of the jaws 4, 5. Accordingly there is either arranged a fixed shaft and a corresponding hole (not shown) within the pivot elements 41, 51 or the pivot elements 41, 51 arc arranged with stub shaft members, to facilitate pivoting motion thereof. The pivoting axis 42, 52 is positioned adjacent a mid-distance between the upper gripping surface level 40 and the bottom point of each recess 7. When using pivoting elements 41, 51 the radius of curvature of the interacting surface 9 may preferably be larger than when using fixed surfaces.

As a consequence of using a pivoting element 41, 51 the point of intersection 10 may vary, depending on the object that is to be gripped. When using the device for a hexagonal object (120°), as indicated with full lines in FIG. 6, the pivoting element 41, 51 will be positioned automatically when getting into contact with the object in a position presenting an intersection point 10′ which is relatively close to the outer level of the gripping surface 40, 50, whereas if a square object(90°) is gripped the intersection point 10″ will be positioned further away from said level 40, 50. The surface of the pivoting element will adapt to the contours of the object that is being gripped. Accordingly the use of the pivoting element will provide an even grade of flexibility of grip ability for a tool in accordance with the invention, due to the ability to adapt to any kind of form of the object, and maintaining essentially balanced vectors acting on the object within each recess 7 providing safe and gentle gripping.

In FIG. 7 there is shown a further alternative in accordance with the invention. In this embodiment one of the jaws 5 does not extend all the way out to the outer part of the opening of the grip 3, but ends adjacent the latitudinal line L passing through the intersection point, as explained in relation to the above presented embodiments. The other jaw 4 presents a design generally that have been described above, i.e. a recess 7 with two opposing arch-shaped surfaces 8, 9. As is evident for the skilled person the design shown in FIG. 7 may merely be used for providing torque in one direction. However, as is also evident for the skilled person, torque may also be applied in the other direction to an object by simply turning the tool around to having it facing in the opposite direction. A big advantage with this kind of alternate design is that it presents a more compact tool thanks to the fact that there exists no protruding portion extending further on from the arch-shaped surface 9 of the shorten jaw 5. As a consequence such a tool may be used also in situations where there are blocking objects that may hinder unscrewing/locking of the object/screw/nut. Moreover, it provides the advantage that any object with a size of flat-to-flat equal to the distance between surface 9 of jaw 5 and surface 8 of jaw 4, i.e. 4/6/8 sides nut/bolt, will suit the implementation of high torque on this object without damaging its corners and while reducing the tendency of the object to escape from grip 3. Furthermore such a tool will provide for a very cost efficient embodiment in accordance with the invention.

In FIGS. 10 and 11 there is shown a slightly altered modification of a tool 1 in accordance with FIG. 7. The same basic principal is used for the tool 1 in FIGS. 10 and 11 as in FIG. 7, i.e. merely using one arch-shaped surface 9 at one of the jaws 5 to provide grip safe torque. Further the embodiment in FIGS. 10 and 11 there is shown a protrusion of the jaw 5 beyond the arch-shaped surface 9 in conjunction with an extended gap 70 that extends outwardly (in direction to the opening of the grip 3),from the and onwards. Hereby there is created space 70 that enables an object to be enclosed by the jaws 4, 5 and at the same time enabling rotation of the tool 1 without applying torque, a limited degree. Hence, thanks to the space/gap the object may be moved into the gripping recess 7. Furthermore it is shown that the outer portion of the jaws 4, 5 present on one side a similar kind of upper gripping surface 40 as presented above, and also a further, outwardly positioned, gripping surface 50b that is positioned at a distance x away from the level 50a that normally would be seen as the upper gripping surface of the second jaw. Thanks to this arrangement an object may be more quickly and easily screwed/unscrewed by merely using the gripping surfaces 40, 50b adjacent the opening grip, e.g. once the object has been loosened by the use of the recess 7.

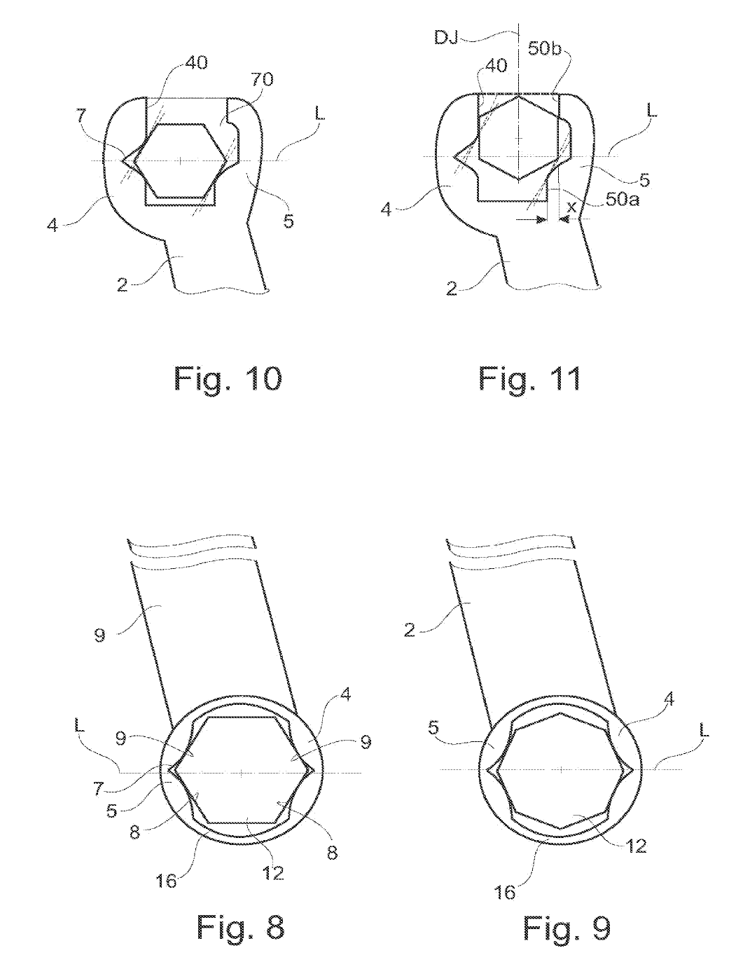

In FIGS. 8 and 9 there is shown a further embodiment in accordance with the invention. The basic principle is the same as in all other shown embodiments, but a major difference resides in the fact that it does not relate to an open ended tool, but a tool where the two opposing jaws 4, 5 have been closed by an outer wall 16, such that it forms a box wrench or a ring wrench. Furthermore, as shown in FIGS. 8 and 9 it may be seen that an advantage in accordance with the invention, using opposing recesses 7 with arch-shaped surfaces 8, 9, may easily provide fitting of very different kind of objects, e.g. hexagonal and octagonal, when using the very same tool.

### ADVANTAGES OF THE INVENTION

A number of advantages are achieved with the present invention. The most obvious is that one and the same tool may be used for many more shapes and sizes than what it was designed for. Another advantage of the present invention is that worn or damaged contact surfaces on for example nuts, bolts and screws do not hinder them from being tightened or untightened. A further advantage with the present invention is that it applies torque to and between objects that are very sensitive to negative damage in a reliable and very gentle manner.

Even if certain preferred embodiments have been described in detail, variations and modifications can within the scope of the invention become evident for specialists in the field and all such are regarded as falling within the scope of the following claims. It is conceivable for example that the present invention be designed with a ratchet function such as in a so called ratchet wrench or similar design. It is even conceivable that a tool with at least three jaws could be developed.

1. A tool for applying torque to a maneuvered object, such as for example a screw head or nut, comprising:
a grip comprising at least a first jaw, and at least a second jaw where the first jaw and the second jaw are connected to at least one lever (arm), wherein at least one of the jaws include at least one recess comprising a first contact surface and a second contact surface, wherein at least one of the first or second contact surfaces is arch-shaped with the depth of the recess between about 0.1 and about 0.6 of the width of the contact surfaces as measured at the extension of the contact surfaces, and the radius of the arch-shapes between about 0.3 and about 1.5 of the depth of the recess, and wherein the arched shape provides a mechanical equilibrium of vectors contributing to prevent the tendency of said object to escape from the grip, the first and second contact surfaces of the first jaw and the second jaw making contact with the maneuvered object, such as for example a screw head or nut, when applying torque to the maneuvered object.

2. The tool of claim 1, wherein at least one of the jaws includes at least one recess with a first contact surface and a second contact surface of which both contact surfaces are arch-shaped.

3. The tool of claim 2, wherein a first arch-shaped contact surface and a second arch-shaped contact surface essentially converge at a point or converge into a point and that the direction of the arch-shaped convergence is essentially in a latitudinal direction in relation to the jaws.

4. The tool of claim 1, characterized in that the jaws make up an accessory to an existing tool's jaws.

5. The tool of claim 1, characterized in that the relative position of the jaws may be adjusted with a maneuvering organ.

6. The tool of claim 5, wherein the maneuvering organ comprises a screw function where the rotating movement is transferred via at least one gear so that the jaws move in relation to each other.

7. (canceled)

8. The tool of claim 1, wherein at least one of the contact surfaces are entirely or partly fitted with transversal grooves in one or more directions.

9. (canceled)

10. The tool of claim 1, characterized in that at least one pivotable element is positioned to form at least one of said arch-shaped contact surfaces.

11. The tool according to claim 1 further comprising a pivotable element pivotably arranged around a fixed axis in relation to its jaw.

12. A method for applying torque to a maneuvered object, such as for example a screw head or nut, including the steps of providing a tool with a grip comprising at least a first jaw, and at least a second jaw where the first jaw and the second jaw are connected to at least one lever (arm), wherein at least one jaw include at least one recess, characterized by providing at least one of the jaws to include at least one recess with a first contact surface and a second contact surface, wherein at least one of said contact surfaces is arch-shaped providing a mechanical equilibrium of vectors contributing to prevent the tendency of said object to escape from the grip.

13. The method of claim 12, wherein at least one of the jaws includes at least one recess with a first contact surface and a second contact surface of which both contact surfaces and are arch-shaped.

14. The method of claim 13, wherein a first arch-shaped contact surface and a second arch-shaped contact surface essentially converge at a point or converge into a point and that the direction of the arch-shaped convergence is essentially in a latitudinal direction in relation to the jaws and.

15. The method of claim 12, wherein said jaws make up an accessory and to an existing tool's jaws.
